(19) United States
(12) Patent Application Publication
(10) Pub. No.: US 2026/0339229 A1
(43) Pub. Date: Oct. 29, 2026

(54) IMAGE FORMING APPARATUS

(71) Applicant: BROTHER KOGYO KABUSHIKI KAISHA, Nagoya (JP)

(72) Inventors: Shintaro Sakaguchi, Nagoya (JP); Sota Yanagihara, Seto (JP)

(73) Assignee: BROTHER KOGYO KABUSHIKI KAISHA, Nagoya (JP)

(21) Appl. No.: 19/559,584

(22) Filed: Mar. 6, 2026

(30) Foreign Application Priority Data
Apr. 24, 2025 (JP) 2025-072236

(51) Int. Cl. G03G 15/01; G03G 15/00; G03G 21/16; G03G 21/18

(52) U.S. Cl. CPC G03G 15/0121; G03G 15/0131; G03G 15/0189; G03G 15/5058; G03G 15/55; G03G 15/757; G03G 21/1633; G03G 21/1814; G03G 21/1857

(57) ABSTRACT

An image forming apparatus includes a first photosensitive drum, a first development roller, at least one motor, a separation mechanism, a charger, an exposure unit, a transfer unit, a sensor, and a controller. The separation mechanism moves the first development roller between a contact position and a separated position. The transfer unit includes a transfer belt that transfers a toner image formed on the first photosensitive drum to a transfer medium. The controller performs a print preparation process of positioning the first development roller at the separated position, rotating the first development roller and the first photosensitive drum, and charging the first photosensitive drum. The controller performs an abnormality inspection process in which a test image is formed on the first photosensitive drum, a transfer bias is applied to the transfer unit, and presence or absence of the test image on the transfer belt is determined.

### REFERENCE TO RELATED APPLICATIONS

This application claims priority from Japanese Patent Application No. 2025-072236 filed on Apr. 24, 2025. The entire contents of the priority application are incorporated herein by reference.

### BACKGROUND ART

An image forming apparatus known in the art executes a contact operation and a separation operation for moving a developing unit between a contact position and a separated position in order to extend the life of the developing unit. In order to detect an abnormality in this operation, a time required for a toner image to move from a development position to a detection position is compared with a time from when the contact operation is started until the toner image is detected. When the time from when the contact operation is started until the toner image is detected is shorter than the time required for the toner image to move from the development position to the detection position, a controller determines that the separation operation is not normally performed.

### SUMMARY

In a case where a separation abnormality is determined by such a method, it is necessary to perform the determination based on a subtle difference in timing.

It is desirable to provide an image forming apparatus capable of easily detecting an abnormality of a separation mechanism.

In one aspect, an image forming apparatus according to the present disclosure includes a first photosensitive drum, a first development roller, at least one motor, a separation mechanism, a charger, an exposure unit, a transfer unit, a sensor, and a controller.

The first development roller supplies toner to the first photosensitive drum.

The at least one motor rotates the first photosensitive drum and the first development roller.

The separation mechanism moves the first development roller between a contact position in which the first development roller contacts the first photosensitive drum and a separated position in which the first development roller is separated from the first photosensitive drum.

The charger charges the first photosensitive drum.

The exposure unit exposes the first photosensitive drum.

The transfer unit transfers a toner image formed on the first photosensitive drum to a transfer medium. The transfer unit includes a transfer belt and a transfer roller. The transfer belt moves in contact with the first photosensitive drum. The transfer roller nips the transfer belt in combination with the first photosensitive drum.

The sensor detects a toner image on the transfer belt.

The controller executes a print preparation process and an abnormality inspection process.

In the print preparation process, the controller controls the separation mechanism to position the first development roller at the separated position, controls the at least one motor to rotate the first development roller and the first photosensitive drum, and controls the charger to charge the first photosensitive drum.

In the abnormality inspection process, the controller forms a test image on the first photosensitive drum by exposure. Further, the controller applies, to the transfer unit, a transfer bias that enables a toner image to be moved from the first photosensitive drum to the transfer belt. Then, in the abnormality inspection process, the controller determines presence or absence of a toner image of the test image on the transfer belt by the sensor.

Further, in the abnormality inspection process, if the toner image is detected by the sensor, the controller determines that an abnormality exists in the separation mechanism. In the abnormality inspection process, if the toner image is not detected by the sensor, the controller determines that no abnormality exists in the separation mechanism.

When inspecting the separation mechanism for an abnormality, the controller executes the abnormality inspection process following the print preparation process.

When inspecting the separation mechanism for an abnormality, by determining presence or absence of a toner image on the transfer belt, an abnormality of the separation mechanism can be easily determined. Further, since inspection of the abnormality is performed in a state where the first development roller is at the separated position, when the separation mechanism is normal, consumption of toner can be suppressed.

Further, the image forming apparatus may include a second photosensitive drum, a third photosensitive drum, and a fourth photosensitive drum. The second photosensitive drum is disposed downstream of the first photosensitive drum in a movement direction in which the transfer medium moves at a position where the transfer medium faces the first photosensitive drum. The third photosensitive drum is disposed downstream of the second photosensitive drum in the movement direction. The fourth photosensitive drum is disposed downstream of the third photosensitive drum in the movement direction.

The image forming apparatus may include a second development roller, a third development roller, and a fourth development roller. The second development roller supplies toner to the second photosensitive drum. The third development roller supplies toner to the third photosensitive drum. The fourth development roller supplies toner to the fourth photosensitive drum.

The transfer unit may further transfer toner images formed on the second photosensitive drum, the third photosensitive drum, and the fourth photosensitive drum to the transfer medium.

The separation mechanism may further move the second development roller, the third development roller, and the fourth development roller between a contact position and a separated position. The contact position is a position in which each development roller contacts a corresponding photosensitive drum, and the separated position is a position in which each development roller is separated from the corresponding photosensitive drum.

The separation mechanism may be configured to sequentially bring the first development roller, the second development roller, the third development roller, and the fourth development roller into contact with corresponding photosensitive drums in this order in accordance with movement of the transfer medium. The separation mechanism may be configured to sequentially separate the fourth development roller, the third development roller, the second development roller, and the first development roller from corresponding photosensitive drums in this order after completion of development.

The image forming apparatus may further include a main housing, an opening, a cover, and a process unit. The opening is provided in the main housing. The cover opens and closes the opening. The process unit is attachable to and detachable from the main housing through the opening. The process unit includes the first development roller and the first photosensitive drum.

The controller may inspect the separation mechanism for an abnormality when detecting opening or closing of the cover.

The controller may inspect the separation mechanism for an abnormality at each predetermined time interval.

Further, the image forming apparatus may include a main housing and a development cartridge. The development cartridge includes a memory, a first development roller, and a toner case that contains toner. The development cartridge is attachable to and detachable from the main housing.

The memory stores new-product information indicating whether or not the development cartridge is new.

The controller may read new-product information from the memory and may inspect the separation mechanism for an abnormality if it is determined, based on the read new-product information, that the development cartridge is new.

Further, the image forming apparatus may include a main housing and a development cartridge. The development cartridge includes a memory that stores unique identification information, a first development roller, and a toner case that contains toner. The development cartridge is attachable to and detachable from the main housing.

The controller may read unique identification information from the memory. The controller may inspect the separation mechanism for an abnormality if the read unique identification information is different from unique identification information of a development cartridge attached immediately previously.

### BRIEF DESCRIPTION OF DRAWINGS

FIG. 1 is a schematic diagram of an image forming apparatus according to an embodiment.

FIG. 2 is an illustration showing formation of a patch image on a transfer belt.

FIG. 3 is a schematic diagram showing an outline of a driving force transmission system of the image forming apparatus.

FIG. 4 is an illustration showing separation cams, cam followers, shafts, and stoppers.

FIG. 5A is an illustration showing a configuration for moving a development cartridge, and shows a state where the development cartridge is located at a contact position.

FIG. 5B is an illustration showing a configuration for moving the development cartridge, and shows a state where the development cartridge is located at a separated position.

FIG. 6A is a perspective view showing the separation cam and a cam follower located at a non-pushing position.

FIG. 6B is a side view showing the separation cam and the cam follower located at the non-pushing position.

FIG. 7A is a perspective view showing the separation cam and the cam follower located at a pushing position.

FIG. 7B is a side view showing the separation cam and the cam follower located at the pushing position.

FIG. 8A and 8B are perspective views showing a gear cover.

FIG. 9A is a cross-sectional view showing the separation cam, the cam follower, the gear cover, and a spring, and shows a state where the cam follower is located at the non-pushing position

FIG. 9B is a cross-sectional view showing the separation cam, the cam follower, the gear cover, and the spring, and shows a state where the cam follower is located at the pushing position.

FIG. 10 is a timing chart according to the embodiment showing timing of a rotation operation of a photosensitive drum, a rotation operation of a development roller, contact/separation operations of development rollers for respective colors of yellow, magenta, cyan, and black, and an exposure operation.

FIG. 11 is a schematic diagram showing an example of an image forming apparatus in a state where an abnormality of a separation mechanism has occurred.

FIG. 12 is a flowchart for executing inspection of the separation mechanism for an abnormality.

FIG. 13 is a timing chart for executing inspection of the separation mechanism for an abnormality showing timing of the rotation operation of the photosensitive drum, the rotation operation of a development roller, contact/separation operations of development rollers for respective colors of yellow, magenta, cyan, and black, and the exposure operation.

### DESCRIPTION

Next, an embodiment of an image forming apparatus will be described in detail with reference to the drawings as appropriate.

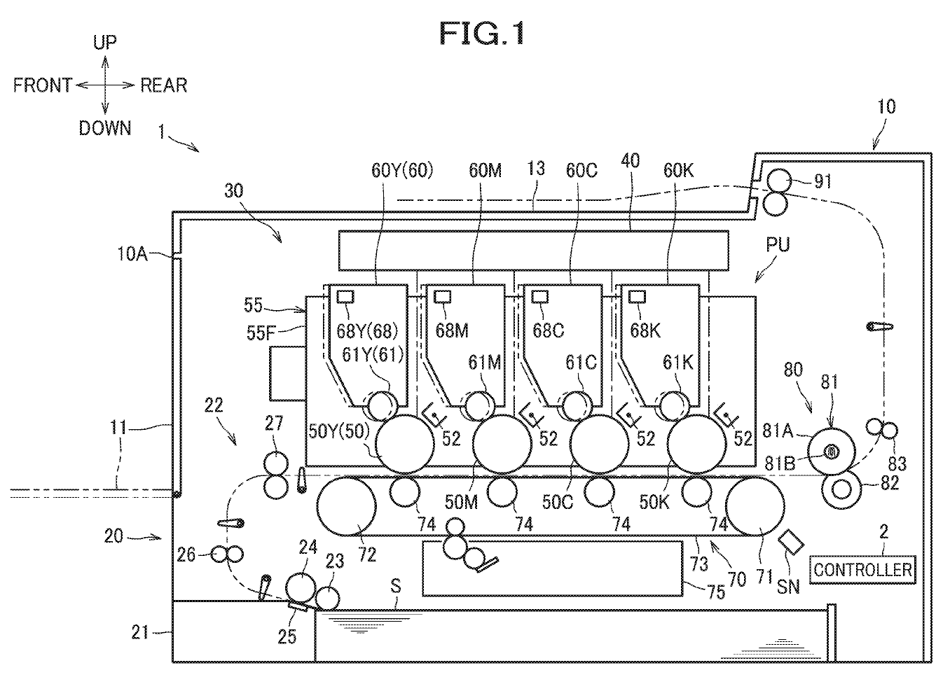

As shown in FIG. 1, an image forming apparatus 1 according to the embodiment is a color printer, and comprises a housing 10 as an example of a main housing, a front cover 11, a sheet feeder unit 20, an image forming unit 30, a second ejection roller 91 as an ejection roller, a controller 2, density sensors SN, and the like. In the present embodiment, the left side in FIG. 1 corresponds to “front” and the right side in FIG. 1 corresponds to “rear”. The upper side in FIG. 1 corresponds to “up” and the lower side in FIG. 1 corresponds to “down”. The front side of the drawing sheet in FIG. 1 corresponds to “right” and the back side of the drawing sheet in FIG. 1 corresponds to “left”.

The housing 10 has an opening 10A at a front portion thereof. The front cover 11 opens and closes the opening 10A. Specifically, the front cover 11 is rotatable with respect to the housing 10 between a closed position shown by a solid line and an open position shown by a chain double-dotted line. The closed position is a position that covers the opening 10A, and the open position is a position that uncovers the opening 10A.

The sheet feeder unit 20 includes a sheet tray 21 and a sheet feeder mechanism 22. Sheets S as examples of transfer media are contained in the sheet tray 21. The sheet feeder mechanism 22 is a mechanism that receives a driving force to feed each of the sheets S toward photosensitive drums 50 (50Y, 50M, 50C, 50K), which will be described later, of the image forming unit 30. The sheet feeder mechanism 22 includes a pickup roller 23, a separation roller 24, a separation pad 25, a conveyance roller 26, and a registration roller 27.

The sheet feeder mechanism 22 feeds the sheets S from the sheet tray 21 by the pickup roller 23. Next, the sheet feeder mechanism 22 separates each sheet S one from the others between the separation roller 24 and the separation pad 25. Thereafter, the sheet feeder mechanism 22 feeds the sheet S toward the image forming unit 30 by the conveyance roller 26 and the registration roller 27.

The image forming unit 30 includes an exposure unit 40, a process unit PU, a transfer unit 70, and a fixing device 80.

The exposure unit 40 includes, for example, a light source, a deflector, lenses, and mirrors. The exposure unit 40 emits light beams shown by chain-dotted lines to expose surfaces of the photosensitive drums 50.

The process unit PU includes a plurality of photosensitive drums 50, a plurality of development cartridges 60, and a drawer 55.

The photosensitive drums 50 include a photosensitive drum 50Y as an example of a first photosensitive drum, a photosensitive drum 50M as an example of a second photosensitive drum, a photosensitive drum 50C as an example of a third photosensitive drum, and a photosensitive drum 50K as an example of a fourth photosensitive drum. The photosensitive drum 50Y corresponds to yellow. The photosensitive drum 50M corresponds to magenta. The photosensitive drum 50C corresponds to cyan. The photosensitive drum 50K corresponds to black. The four photosensitive drums 50, i.e., the photosensitive drum 50Y, the photosensitive drum 50M, the photosensitive drum 50C, and the photosensitive drum 50K are arranged in a conveyance direction of the sheet S from upstream toward downstream in this order.

Specifically, the photosensitive drum 50M is disposed downstream of the photosensitive drum 50Y in the conveyance direction of the sheet S. The photosensitive drum 50C is disposed downstream of the photosensitive drum 50M in the conveyance direction of the sheet S. The photosensitive drum 50K is disposed downstream of the photosensitive drum 50C in the conveyance direction of the sheet S.

In the present specification and drawings, Y, M, C, and K are added to reference numerals when distinguishing colors for members corresponding to respective colors, and Y, M, C, and K are not added to the reference numerals when not distinguishing colors.

The drawer 55 is movable to an inner position and an outer position through the opening 10A of the housing 10 in a direction in which the photosensitive drums 50 are arranged. The inner position is a position where the drawer 55 is installed in the housing 10, and the outer position is a position where at least a part of the drawer 55 is exposed outside the housing 10. In the present embodiment, the outer position is a position in which the drawer 55 is pulled out forward from the inner position. In the present embodiment, the drawer 55 is installable into and removable from the housing 10.

The drawer 55 has a frame 55F. The frame 55F rotatably supports the four photosensitive drums 50 (50Y, 50M, 50C, 50K). The frame 55F supports four chargers 52. The chargers 52 charge surfaces of the corresponding photosensitive drums 50.

The development cartridges 60 are provided corresponding to the respective photosensitive drums 50. Each development cartridge 60 includes a development roller 61 and a development memory 68. The development roller 61 supplies toner to a corresponding photosensitive drum 50. The development memory 68 is a memory that stores information regarding the development cartridge 60. The development memory 68 stores, for example, new-product information indicating whether the development cartridge 60 is new, and unique identification information such as a serial number.

The development cartridges 60 include a development cartridge 60Y as an example of a first development cartridge, a development cartridge 60M as an example of a second development cartridge, a development cartridge 60C as an example of a third development cartridge, and a development cartridge 60K as an example of a fourth development cartridge. The development cartridge 60Y has a toner case that contains yellow toner. The development cartridge 60M has a toner case that contains magenta toner. The development cartridge 60C has a toner case that contains cyan toner. The development cartridge 60K has a toner case that contains black toner.

The development rollers 61 include a development roller 61Y as an example of a first development roller, a development roller 61M as an example of a second development roller, a development roller 61C as an example of a third development roller, and a development roller 61K as an example of a fourth development roller. The development memories 68 include a development memory 68Y, a development memory 68M, a development memory 68C, and a development memory 68K.

The development cartridge 60Y includes the development roller 61Y and the development memory 68Y. The development roller 61Y supplies toner to the photosensitive drum 50Y. The development memory 68Y stores information regarding the development cartridge 60Y.

The development cartridge 60M includes the development roller 61M and the development memory 68M. The development roller 61M supplies toner to the photosensitive drum 50M. The development memory 68M stores information regarding the development cartridge 60M.

The development cartridge 60C includes the development roller 61C and the development memory 68C. The development roller 61C supplies toner to the photosensitive drum 50C. The development memory 68C stores information regarding the development cartridge 60C.

The development cartridge 60K includes the development roller 61K and the development memory 68K. The development roller 61K supplies toner to the photosensitive drum 50K. The development memory 68K stores information regarding the development cartridge 60K.

The development roller 61Y is movable with respect to the photosensitive drum 50Y between a contact position in which the development roller 61Y contacts the photosensitive drum 50Y and a separated position in which the development roller 61Y is separated from the photosensitive drum 50Y. The development roller 61M is movable with respect to the photosensitive drum 50M between a contact position in which the development roller 61M contacts the photosensitive drum 50M and a separated position in which the development roller 61M is separated from the photosensitive drum 50M. The development roller 61C is movable with respect to the photosensitive drum 50C between a contact position in which the development roller 61C contacts the photosensitive drum 50C and a separated position in which the development roller 61C is separated from the photosensitive drum 50C. The development roller 61K is movable with respect to the photosensitive drum 50K between a contact position in which the development roller 61K contacts the photosensitive drum 50K and a separated position in which the development roller 61K is separated from the photosensitive drum 50K.

The frame 55F of the drawer 55 detachably supports the development cartridges 60 (60Y, 60M, 60C, 60K). The development cartridges 60 are replaceable, respectively, in a state where the drawer 55 is located at the outer position, or in a state where the drawer 55 is removed from the housing 10.

As shown in FIG. 1, each development cartridge 60 is supported by the frame 55F to be movable forward and rearward between a first position shown by a solid line and a second position shown by a chain double-dotted line. The first position is a position for positioning a corresponding development roller 61 at the contact position, and the second position is a position for positioning the corresponding development roller 61 at the separated position.

Specifically, the development cartridge 60Y is movable with respect to the photosensitive drum 50Y between the first position for positioning the development roller 61Y at the contact position and the second position for positioning the development roller 61Y at the separated position. In other words, the development cartridge 60Y is movable with respect to the photosensitive drum 50Y between the first position in which the development roller 61Y contacts the photosensitive drum 50Y and the second position in which the development roller 61Y is separated from the photosensitive drum 50Y.

Further, the development cartridge 60M is movable with respect to the photosensitive drum 50M between the first position for positioning the development roller 61M at the contact position and the second position for positioning the development roller 61M at the separated position. In other words, the development cartridge 60M is movable with respect to the photosensitive drum 50M between the first position in which the development roller 61M contacts the photosensitive drum 50M and the second position in which the development roller 61M is separated from the photosensitive drum 50M.

Further, the development cartridge 60C is movable with respect to the photosensitive drum 50C between the first position for positioning the development roller 61C at the contact position and the second position for positioning the development roller 61C at the separated position. In other words, the development cartridge 60C is movable with respect to the photosensitive drum 50C between the first position in which the development roller 61C contacts the photosensitive drum 50C and the second position in which the development roller 61C is separated from the photosensitive drum 50C.

Further, the development cartridge 60K is movable with respect to the photosensitive drum 50K between the first position for positioning the development roller 61K at the contact position and the second position for positioning the development roller 61K at the separated position. In other words, the development cartridge 60K is movable with respect to the photosensitive drum 50K between the first position in which the development roller 61K contacts the photosensitive drum 50K and the second position in which the development roller 61K is separated from the photosensitive drum 50K.

The transfer unit 70 includes a drive roller 71, a follower roller 72, an endless transfer belt 73, and four transfer rollers 74. The transfer belt 73 is stretched between the drive roller 71 and the follower roller 72, and an outer surface thereof contacts the four photosensitive drums 50. Each transfer roller 74 is disposed to face an inner surface of the transfer belt 73 and nips the transfer belt 73 in combination with a corresponding photosensitive drum 50.

The fixing device 80 is a device that fixes a toner image transferred to the sheet S on the sheet S. The fixing device 80 includes a heating unit 81, a pressure unit 82, and a first ejection roller 83 as an ejection roller. The heating unit 81 includes a heating roller 81A and a heater 81B. The heating roller 81A is a cylindrical roller made of metal. The heater 81B heats the heating roller 81A, and is disposed to pass through an inside of the heating roller 81A.

The pressure unit 82 nips the sheet S in combination with the heating unit 81. Specifically, the pressure unit 82 is a pressure roller that nips the sheet S in combination with the heating roller 81A. The pressure roller is a roller having a rubber layer covering a periphery of a metal core. The fixing device 80 receives a driving force to convey the sheet S between the heating roller 81A of the heating unit 81 and the pressure unit 82. Further, the fixing device 80 receives a driving force to convey the sheet S by the first ejection roller 83.

The image forming unit 30 uniformly charges the surfaces of the photosensitive drums 50 by the chargers 52, and then exposes the surfaces by the light beams emitted from the exposure unit 40. The image forming unit 30 thereby forms an electrostatic latent image based on image data on each photosensitive drum 50. Further, the image forming unit 30 supplies toner contained in the development cartridge 60 from the development roller 61 located at the contact position to the photosensitive drum 50. Thus, the image forming unit 30 forms a toner image on the photosensitive drum 50.

The image forming unit 30 transfers the toner image formed on each photosensitive drum 50 to the sheet S by conveying the sheet S supplied from the sheet feeder unit 20 between each photosensitive drum 50 and the corresponding transfer roller 74. Thereafter, the image forming unit 30 fixes the toner image on the sheet S by conveying the sheet S on which the toner image has been transferred between the heating roller 81A and the pressure unit 82.

The first ejection roller 83 and the second ejection roller 91 receive a driving force to eject the sheet S from between the heating unit 81 and the pressure unit 82 to outside the housing 10. Specifically, the first ejection roller 83 and the second ejection roller 91 eject the sheet S on which the toner image has been fixed to an output tray 13.

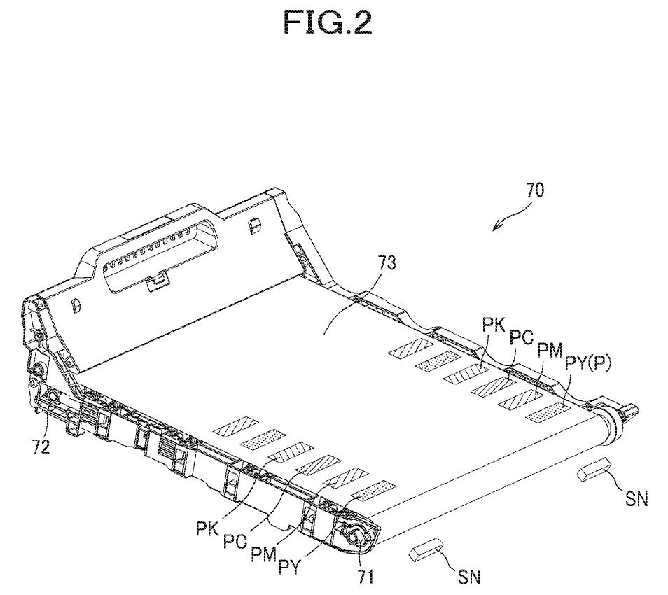

As shown in FIG. 2, the density sensors SN are capable of measuring densities of toner patch images P formed on the transfer belt 73. The patch images P are toner test images for correcting densities of toner images. The density sensors SN face the surface of the transfer belt 73. As an example, each density sensor SN is an optical sensor including a light emitting element and a light receiving element. The light emitting element emits light toward the transfer belt 73. The light receiving element receives light emitted from the light emitting element and reflected by the transfer belt 73.

The image forming unit 30 is configured to form the patch images P on the transfer belt 73. When forming the patch images P, the image forming unit 30 transfers the toner image formed on each photosensitive drum 50 to the transfer belt 73 by the corresponding transfer roller 74. The image forming unit 30 is configured to form patch images PY, PM, PC, and PK corresponding to yellow, magenta, cyan, and black on the transfer belt 73. The patch images P formed on the transfer belt 73 are collected by a belt cleaner (not shown) after densities are measured by the density sensors SN.

For example, correction of densities of toner images is executed when any of the following conditions (1) to (3) is satisfied.
(1) A predetermined number of sheets has been printed.
(2) Environmental conditions, such as temperature and humidity, have significantly changed.
(3) An instruction has been provided from a user.

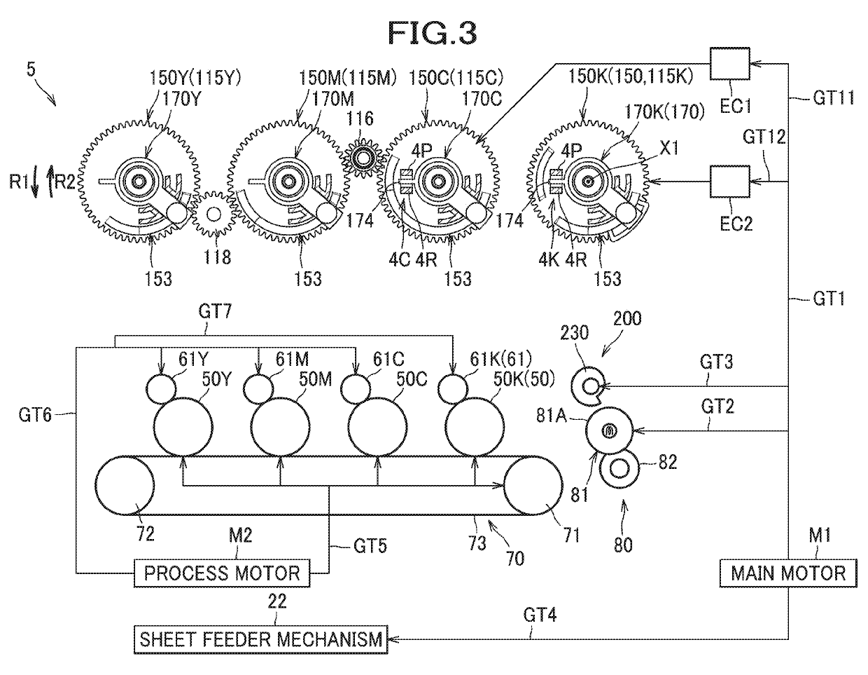

As shown in FIG. 3, the image forming apparatus 1 further includes a main motor M1, a process motor M2 as an example of a motor, a separation mechanism 5, and a nip pressure adjusting mechanism 200.

The main motor M1 is a motor that drives separation cams 150 of the separation mechanism 5, the fixing device 80, the nip pressure adjusting mechanism 200, and the sheet feeder mechanism 22. In other words, the separation cams 150 of the separation mechanism 5, the fixing device 80, the nip pressure adjusting mechanism 200, and the sheet feeder mechanism 22 receive a driving force from the main motor M1. The main motor M1 is rotatable in forward and reverse directions. The main motor M1 rotates in a forward direction when conveying the sheet S from the sheet tray 21 toward the output tray 13 during printing for forming an image on the sheet S.

The process motor M2 is a motor that drives the photosensitive drums 50, the development rollers 61, and the transfer unit 70. In other words, the photosensitive drums 50, the development rollers 61, and the transfer unit 70 receive a driving force from the process motor M2.

As shown in FIG. 3, the image forming apparatus 1 further includes a development separation gear train GT1 as an example of a gear train, a fixing drive gear train GT2, a nip pressure adjusting gear train GT3, a sheet feeder gear train GT4, a drum drive gear train GT5, a first development drive gear train GT6, and a second development drive gear train GT7.

The development separation gear train GT1 is a gear train that transmits a driving force of the main motor M1 to the separation cams 150 (150Y, 150M, 150C, 150K) of the separation mechanism 5. The separation cams 150 are examples of a rotary cam. The development separation gear train GT1 connects the main motor M1 and each of the separation cams 150.

The fixing drive gear train GT2 is a gear train that receives driving force of the main motor M1 from the development separation gear train GT1 and transmits the driving force to the fixing device 80. Specifically, the fixing drive gear train GT2 receives driving force of the main motor M1 from the development separation gear train GT1 and transmits the driving force to the heating roller 81A.

The nip pressure adjusting gear train GT3 is a gear train that receives a driving force of the main motor M1 from the development separation gear train GT1 and transmits the driving force to a nip pressure adjusting cam 230 of the nip pressure adjusting mechanism 200.

The sheet feeder gear train GT4 is a gear train that transmits a driving force of the main motor M1 to the sheet feeder mechanism 22.

The drum drive gear train GT5 is a gear train that transmits a driving force of the process motor M2 to the photosensitive drums 50 (50Y, 50M, 50C, 50K).

The first development drive gear train GT6 is a gear train that transmits a driving force of the process motor M2 to the development rollers 61Y, 61M, and 61C.

The second development drive gear train GT7 is a gear train that transmits a driving force of the process motor M2 to the development roller 61K. Specifically, the second development drive gear train GT7 receives a driving force of the process motor M2 from the first development drive gear train GT6 and transmits the driving force to the development roller 61K.

When the development rollers 61 start rotating upon receiving the driving force of the process motor M2, the development rollers 61 start rotating later than the photosensitive drums 50 due to a mechanical transmission delay in the first development drive gear train GT6 and the second development drive gear train GT7.

The separation mechanism 5 is a mechanism that receives a driving force from the main motor M1 to move the development rollers 61 between the contact position and the separated position. The separation mechanism 5 includes four separation cams 150 and four cam followers 170.

The separation cams 150 are rotatable in forward and reverse directions by receiving a driving force of the main motor M1. The separation cams 150 include a separation cam 150Y, a separation cam 150M, a separation cam 150C, and a separation cam 150K.

The separation cam 150Y rotates by receiving a driving force from the main motor M1 to move the development roller 61Y between the contact position and the separated position. Specifically, the separation cam 150Y moves the development cartridge 60Y between the first position and the second position by rotating, thereby moving the development roller 61Y between the contact position and the separated position.

The separation cam 150M rotates by receiving a driving force from the main motor M1 to move the development roller 61M between the contact position and the separated position. Specifically, the separation cam 150M moves the development cartridge 60M between the first position and the second position by rotating, thereby moving the development roller 61M between the contact position and the separated position.

The separation cam 150C rotates by receiving a driving force from the main motor M1 to move the development roller 61C between the contact position and the separated position. Specifically, the separation cam 150C moves the development cartridge 60C between the first position and the second position by rotating, thereby moving the development roller 61C between the contact position and the separated position.

The separation cam 150K rotates by receiving a driving force from the main motor M1 to move the development roller 61K between the contact position and the separated position. Specifically, the separation cam 150K moves the development cartridge 60K between the first position and the second position by rotating, thereby moving the development roller 61K between the contact position and the separated position.

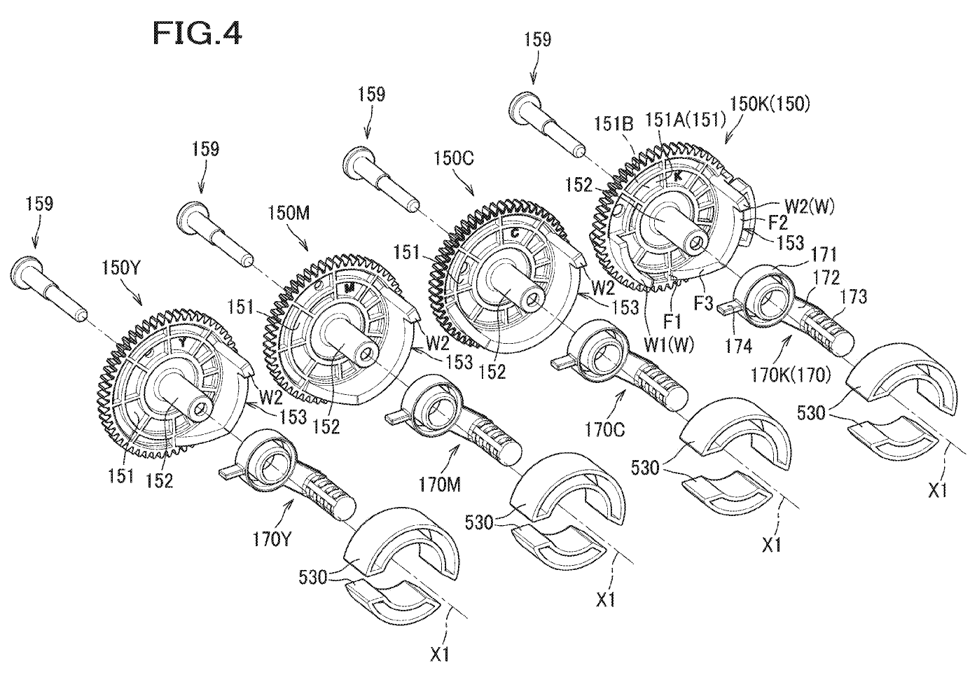

As shown in FIG. 4, the cam followers 170 include a cam follower 170Y, a cam follower 170M, a cam follower 170C, and a cam follower 170K. Each of the cam followers 170 are slidable in an axial direction of a rotation axis of the corresponding separation cam 150. The axial direction of the rotation axis of each separation cam 150 corresponds to a direction in which chain-dotted lines shown in FIG. 4 extend. Hereinafter, the axial direction of the rotation axis of the separation cam 150 is also simply referred to as an “axial direction”. The axial direction is also an axial direction of cam gears 115 (115Y, 115M, 115C, 115K) described later.

The cam follower 170Y is slidable in the axial direction between a pushing position and a non-pushing position in accordance with rotation of the separation cam 150Y (cam gear 115Y). Regarding the cam follower 170Y, the pushing position is a position that pushes the development cartridge 60Y to position the development cartridge 60Y at the second position, and the non-pushing position is a position that positions the development cartridge 60Y at the first position.

The cam follower 170M is slidable in the axial direction between a pushing position and a non-pushing position in accordance with rotation of the separation cam 150M (cam gear 115M). Regarding the cam follower 170M, the pushing position is a position that pushes the development cartridge 60M to position the development cartridge 60M at the second position, and the non-pushing position is a position that positions the development cartridge 60M at the first position.

The cam follower 170C is slidable in the axial direction between a pushing position and a non-pushing position in accordance with rotation of the separation cam 150C (cam gear 115C). Regarding the cam follower 170C, the pushing position is a position that pushes the development cartridge 60C to position the development cartridge 60C at the second position, and the non-pushing position is a position that positions the development cartridge 60C at the first position.

The cam follower 170K is slidable in the axial direction between a pushing position and a non-pushing position in accordance with rotation of the separation cam 150K (cam gear 115K). Regarding the cam follower 170K, the pushing position is a position that pushes the development cartridge 60K to position the development cartridge 60K at the second position, and the non-pushing position is a position that positions the development cartridge 60K at the first position.

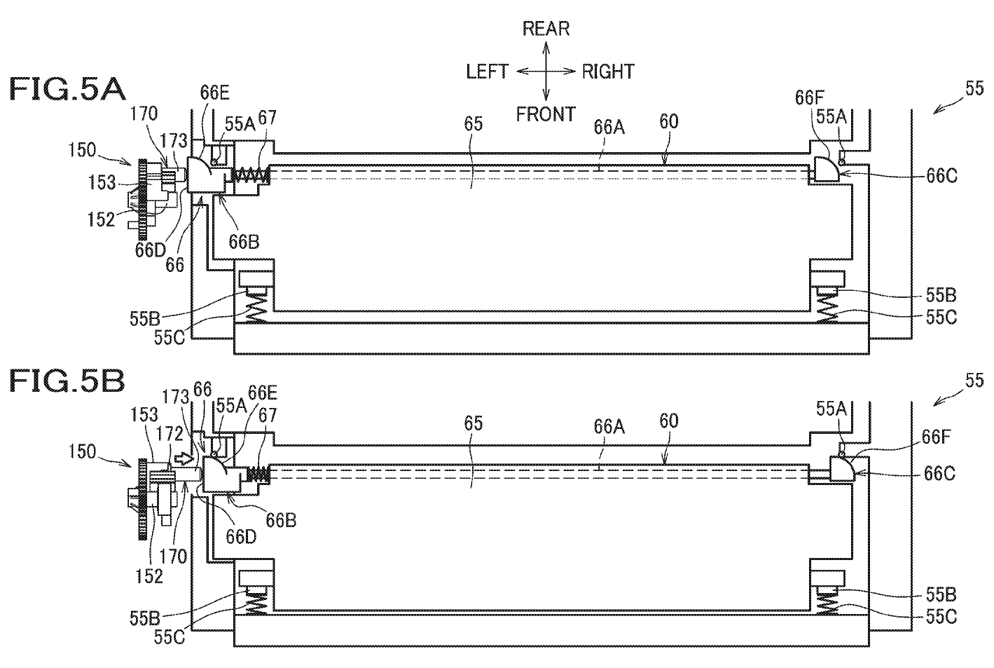

As shown in FIG. 5A, the drawer 55 includes contact portions 55A, a pushing member 55B, and a spring 55C. The contact portions 55A are portions with which a separation shaft 66 described later comes into contact, and is formed by a roller rotatable about an axis extending along an up-down direction. The pushing member 55B is biased rearward by the spring 55C. When the development cartridge 60 is attached to the drawer 55, the pushing member 55B pushes the development cartridge 60 rearward by the biasing force of the spring 55C. Thus, the development cartridge 60 moves to the first position in which the development roller 61 contacts the photosensitive drum 50.

The development cartridge 60 includes the separation shaft 66 and a case 65 that contains toner.

The separation shaft 66 slides in the axial direction by being pushed by the cam follower 170. The separation shaft 66 includes a shaft 66A, a first contact member 66B, and a second contact member 66C. The shaft 66A is supported by the case 65 to be slidable in the axial direction. The first contact member 66B is fixed to one end of the shaft 66A, and the second contact member 66C is fixed to the other end of the shaft 66A.

The first contact member 66B includes a to-be-pushed surface 66D and an inclined surface 66E, and the second contact member 66C includes an inclined surface 66F. The to-be-pushed surface 66D is a surface to-be-pushed by the cam follower 170. The inclined surfaces 66E and 66F are surfaces inclined with respect to a left-right direction. As shown in FIG. 5B, when the separation shaft 66 is pushed by the cam follower 170, the inclined surfaces 66E and 66F contact the contact portions 55A and move the development cartridge 60 forward. Thus, the development cartridge 60 moves to the second position in which the development roller 61 is separated from the photosensitive drum 50. A spring 67 is disposed between the first contact member 66B and the case 65. The spring 67 biases the separation shaft 66 leftward.

As shown in FIG. 4, the separation cams 150 are end face cams. Each separation cam 150 includes a disk portion 151, a boss 152, and a cam portion 153.

The disk portion 151 includes a first base surface 151A and a second base surface 151B.

The first base surface 151A is a surface of the disk portion 151 facing the cam follower 170. In the present embodiment, the first base surface 151A has an uneven shape formed by a plurality of ribs, but the first base surface 151A may be a flat surface. The first base surface 151A is perpendicular to the axial direction.

The second base surface 151B is located opposite to the first base surface 151A in the axial direction. In the present embodiment, the second base surface 151B is a flat surface, but the second base surface 151B may have an uneven shape. The second base surface 151B is perpendicular to the axial direction.

The boss 152 extends in the axial direction from a center of the disk portion 151. The boss 152 has a cylindrical shape.

The cam portion 153 has a function of moving the cam follower 170 in the axial direction. The cam portion 153 protrudes from the disk portion 151 in the axial direction. Specifically, the cam portion 153 protrudes from the disk portion 151 toward one side in the axial direction. The cam portion 153 protrudes from the first base surface 151A of the disk portion 151. The cam portion 153 has an arcuate shape in which a center coincides with the rotation axis of the separation cam 150. In the present embodiment, the length of the cam portion 153 in a rotation direction of the separation cam 150 differs for each color, but may be the same length.

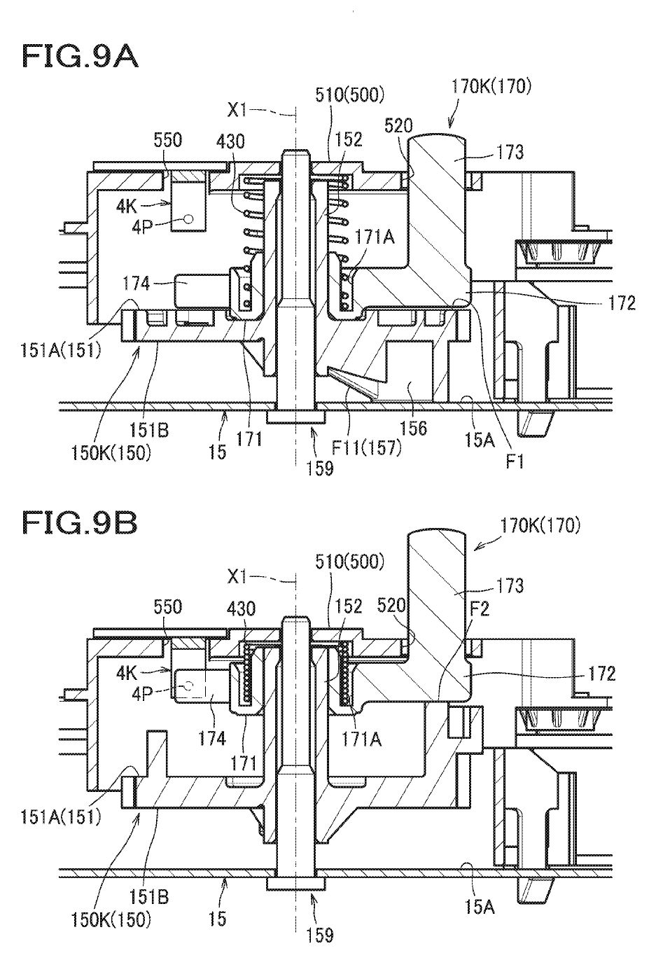

The first base surface 151A has a first surface F1 that positions the cam follower 170 at the non-pushing position. The first surface F1 is a part of the first base surface 151A. As shown in FIG. 9A, when the cam follower 170 is located at the non-pushing position, the first surface F1 faces, in the axial direction, an arm 172 of the cam follower 170 described later. In the present embodiment, the first surface F1 is separated from the arm 172 when the cam follower 170 is located at the non-pushing position, but the first surface F1 may contact the arm 172 when the cam follower 170 is located at the non-pushing position.

Returning to FIG. 4, the cam portion 153 includes a second surface F2 and an inclined surface F3.

The second surface F2 is a surface that holds the cam follower 170 at the pushing position. The second surface F2 is substantially parallel to a plane perpendicular to the rotation axis of the separation cam 150 (cam gear 115).

The inclined surface F3 is a surface that guides the cam follower 170 between the pushing position and the non-pushing position. The inclined surface F3 moves the cam follower 170 from the non-pushing position to the pushing position by pushing the cam follower 170 in a direction away from the first surface F1 in the axial direction. The inclined surface F3 is inclined with respect to a plane perpendicular to the rotation axis of the separation cam 150 (cam gear 115). The inclined surface F3 extends obliquely from the first surface F1 toward the one side in the axial direction. Specifically, the inclined surface F3 is inclined such that the inclined surface F3 is spaced further apart from the first surface F1 as it approaches the second surface F2 in the rotation direction of the separation cam 150.

The inclined surface F3 is located between the first surface F1 and the second surface F2 in the rotation direction of the separation cam 150. The second surface F2 is connected to the inclined surface F3.

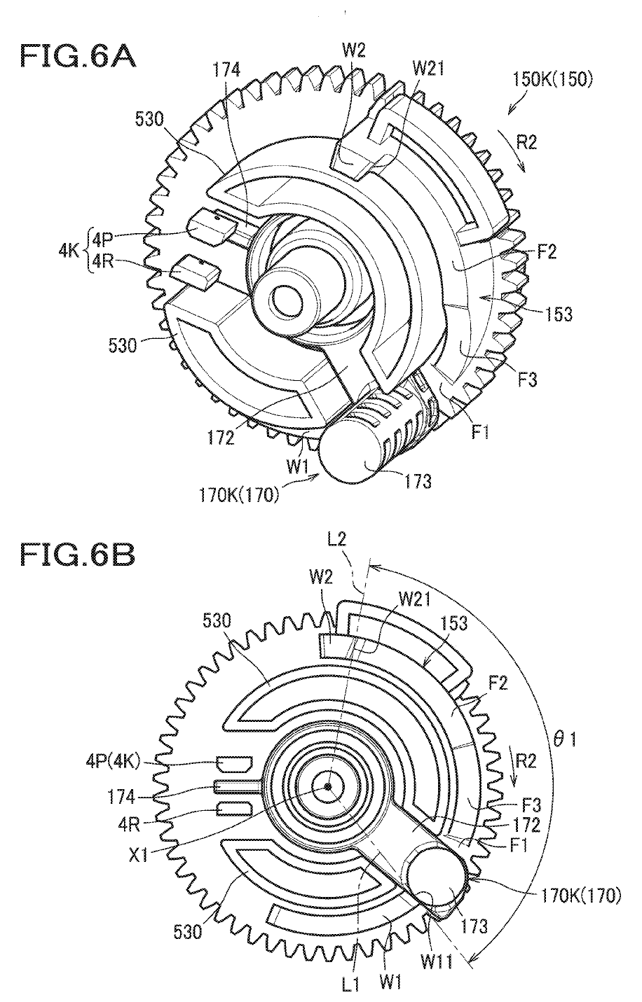

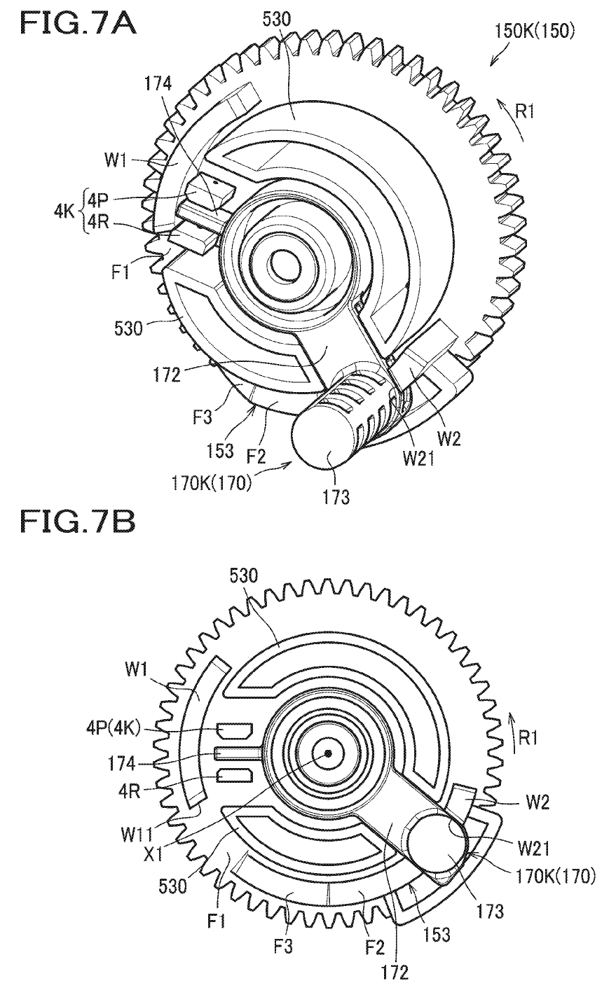

As shown in FIGS. 7A and 7B, when the separation cam 150 rotates in a first rotation direction R1, the inclined surface F3 moves the cam follower 170 from the pushing position to the non-pushing position. The first rotation direction R1 is a rotation direction of the separation cam 150 when the main motor M1 rotates in the forward direction. Further, as shown in FIGS. 6A and 6B, when the separation cam 150 rotates in a second rotation direction R2, the inclined surface F3 moves the cam follower 170 from the non-pushing position to the pushing position. The second rotation direction R2 is a rotation direction of the separation cam 150 when the main motor M1 rotates in the reverse direction. The second rotation direction R2 is opposite to the first rotation direction R1. In FIGS. 6A, 6B, 7A, and 7B, for convenience of explanation, the shape of the first base surface 151A of the separation cam 150 is simplified.

As shown in FIG. 4, the separation cam 150K corresponding to black includes a wall portion W.

The wall portion W includes a first wall portion W1 and a second wall portion W2. In the present embodiment, separation cams 150Y, 150M, and 150C corresponding to colors other than black include only the second wall portion W2 and do not include the first wall portion W1, but may include the first wall portion W1. Since the second wall portion W2 of each of the separation cams 150Y, 150M, and 150C has substantially the same structure as the second wall portion W2 of the separation cam 150K, description thereof is omitted.

The first wall portion W1 and the second wall portion W2 are configured to contact the cam follower 170K in the rotation direction of the separation cam 150K. The first wall portion W1 and the second wall portion W2 have a function of restricting rotation of the separation cam 150K.

The first wall portion W1 protrudes from the first surface F1. The first wall portion W1 has an arcuate shape in which a center coincides with the rotation axis of the separation cam 150K.

The second wall portion W2 protrudes from the second surface F2.

The first wall portion W1, the first surface F1, the inclined surface F3, the second surface F2, and the second wall portion W2 are arranged in this order in the rotation direction of the separation cam 150K. The separation cam 150K is rotatable from a position where the first wall portion W1 contacts the cam follower 170 to a position where the second wall portion W2 contacts the cam follower 170.

More specifically, as shown in FIG. 6B, the first wall portion W1 includes a first side surface W11 that contacts the cam follower 170. The second wall portion W2 includes a second side surface W21 that contacts the cam follower 170. An angle θ1 between a first straight line L1 connecting a rotation axis X1 of the separation cam 150K and the first side surface W11 and a second straight line L2 connecting the rotation axis X1 and the second side surface W21, is 180 degrees or smaller when viewed from the axial direction. In the present embodiment, the angle θ1 between the first straight line L1 and the second straight line L2 is smaller than 180 degrees.

The separation cam 150K rotates about the rotation axis X1. The separation cam 150K rotates between a first phase for positioning the development roller 61K at the contact position and a second phase for positioning the development roller 61K at the separated position. The separation cam 150K rotates toward the first phase by forward rotation of the main motor M1, and rotates toward the second phase by reverse rotation of the main motor M1.

Similarly, each of the separation cams 150Y, 150M, and 150C rotates between a first phase for positioning a corresponding development roller 61 at the contact position and a second phase for positioning the corresponding development roller 61 at the separated position. The separation cams 150Y, 150M, and 150C rotate toward the first phase by forward rotation of the main motor M1. The separation cams 150Y, 150M, and 150C rotate toward the second phase by reverse rotation of the main motor M1.

Each cam follower 170 is located at the non-pushing position when the corresponding separation cam 150 is located at the first phase. Each cam follower 170 is located at the pushing position when the corresponding separation cam 150 is located at the second phase.

When the separation cam 150K is located at the first phase, the first wall portion W1 may contact the cam follower 170K or may be separated from the cam follower 170K. When the separation cam 150K is located at the second phase, the second wall portion W2 may contact the cam follower 170K or may be separated from the cam follower 170K. Similarly, for each separation cam 150 other than black, when the separation cam 150 is located at the second phase, the corresponding second wall portion W2 may contact the corresponding cam follower 170 or may be separated from the corresponding cam follower 170.

An angle from the first phase to the second phase is 180 degrees or smaller. In the present embodiment, the angle from the first phase to the second phase is smaller than 180 degrees.

The first phase may be the same for all colors, or may be different for each color. The second phase similarly may be the same for all colors, or may be different for each color. In the present embodiment, the first phases corresponding to the respective colors are all the same. Further, the second phases are phases different for each color.

As shown in FIG. 4, the image forming apparatus 1 further includes four shafts 159 and a metal sheet 15 (see FIGS. 9A and 9B) as an example of a support member. The metal sheet 15 is a member that rotatably supports gears of the respective gear trains. As shown in FIGS. 9A and 9B, the shafts 159 are fixed to the metal sheet 15. The separation cam 150 (cam gear 115) is rotatably supported by the metal sheet 15 by engagement of the boss 152 with the shaft 159.

The metal sheet 15 has a contact surface 15A that contacts the separation cam 150. The second base surface 151B faces the contact surface 15A. The boss 152 protrudes from the first base surface 151A and also protrudes from the second base surface 151B.

As shown in FIG. 4, the cam follower 170 includes a slide shaft 171, an arm 172, a pin 173, and a protrusion 174 as an example of a first detected portion and a second detected portion.

The slide shaft 171 is slidable in the axial direction. Specifically, the slide shaft 171 has a cylindrical shape. By being engaged with the boss 152 of the separation cam 150, the slide shaft 171 is slidable in the axial direction with respect to the boss 152. Thus, the cam follower 170 is slidable in the axial direction between the non-pushing position shown in FIGS. 6A and 6B and the pushing position shown in FIGS. 7A and 7B.

The arm 172 extends from the slide shaft 171 in a direction perpendicular to the axial direction. Specifically, the arm 172 extends from the slide shaft 171 outward in a radial direction of the slide shaft 171. The arm 172 has a plate shape. The arm 172 of the cam follower 170K corresponding to black is capable of contacting the first wall portion W1 in the rotation direction of the separation cam 150K. The arm 172 corresponding to each color is capable of contacting the corresponding second wall portion W2 in the rotation direction of the corresponding separation cam 150.

The pin 173 extends from the arm 172 in the axial direction. Specifically, the pin 173 extends from an end portion of the arm 172 farther from the slide shaft 171 toward the one side in the axial direction. The pin 173 has a cylindrical shape and has a convex curved surface at a distal end. The distal end of the pin 173 pushes the development cartridge 60 when the cam follower 170 moves from the non-pushing position to the pushing position. Specifically, the distal end of the pin 173 pushes the to-be-pushed surface 66D (see FIG. 5B) of the separation shaft 66 provided on the development cartridge 60.

The protrusion 174 extends from the slide shaft 171 in a direction perpendicular to the axial direction. Specifically, the protrusion 174 extends from the slide shaft 171 toward the outside in the radial direction of the slide shaft 171. The protrusion 174 extends in a direction different from a direction in which the arm 172 extends. In the embodiment, the protrusion 174 extends forward from the slide shaft 171, and the arm 172 extends obliquely rearward and downward from the slide shaft 171. The protrusion 174 moves in the axial direction by movement of the cam follower 170 in the axial direction in accordance with rotation of the separation cam 150.

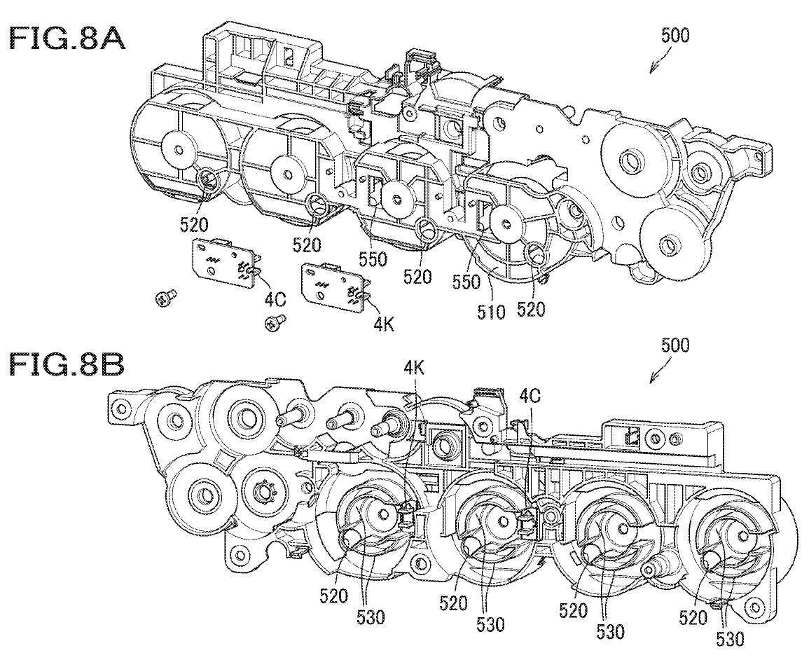

The image forming apparatus 1 further includes stoppers 530. Four sets of the stoppers 530 are provided corresponding to the four cam followers 170. The stoppers 530 restrict the cam follower 170 from rotating in the rotation direction of the separation cam 150. Specifically, as shown in FIGS. 8A and 8B, the image forming apparatus 1 includes a gear cover 500 as an example of a cover, and the gear cover 500 includes the stoppers 530.

The gear cover 500 covers the separation cams 150 (cam gears 115) and the cam followers 170 by being fixed to the metal sheet 15 (see FIGS. 9A and 9B). The gear cover 500 includes a cover wall 510. The cover wall 510 is a wall that covers the separation cams 150 and the cam followers 170, and faces the metal sheet 15 in the axial direction in a state where the gear cover 500 is fixed to the metal sheet 15.

Each stopper 530 extends from the cover wall 510 toward the corresponding separation cam 150 in the axial direction. The stopper 530 has a wall shape. Each set of stoppers 530 straddles the arm 172 of the cam follower 170 from both sides in a circumferential direction of the slide shaft 171 (see FIGS. 6A, 6B, 7A and 7B). Thus, rotation of the cam follower 170 about the boss 152 is restricted.

The cover wall 510 further includes four insertion holes 520 and two through holes 550. The insertion holes 520 are through holes into which the pins 173 of the cam followers 170 are inserted (see FIGS. 9A and 9B). The through holes 550 are holes for attaching sensors 4K and 4C shown in FIG. 8B to the gear cover 500.

As shown in FIGS. 9A and 9B, the image forming apparatus 1 further includes a spring 430. Four springs 430 corresponding to the four cam followers 170 are provided. Each spring 430 biases a corresponding cam follower 170 from the pushing position shown in FIG. 9B toward the non-pushing position shown in FIG. 9A. As an example, the spring 430 is a compression coil spring. The spring 430 is located between the gear cover 500 and the slide shaft 171 of the cam follower 170. Specifically, the spring 430 is located between the cover wall 510 and the slide shaft 171.

The slide shaft 171 includes a recess 171A. The recess 171A is an annular recess and opens toward the cover wall 510 in the axial direction. At least one end portion of the spring 430 is disposed in the recess 171A. By the slide shaft 171 including the recess 171A, positional displacement of the spring 430 can be suppressed.

As shown in FIGS. 7A and 7B, when the development cartridge 60 is located at the second position, that is, when the development roller 61 is located at the separated position, the cam follower 170 is located at the pushing position where the arm 172 is held by the second surface F2 of the separation cam 150.

When the main motor M1 rotates in the forward direction, the separation cam 150 rotates in the first rotation direction R1. Then, the arm 172 of the cam follower 170 is guided from the second surface F2 to the inclined surface F3, and slides on the inclined surface F3 and slides off and comes off the cam portion 153. That is, when the main motor M1 rotates in the forward direction, the cam follower 170 relatively moves in a direction from the second surface F2 toward the first surface F1 via the inclined surface F3 with respect to the separation cam 150. As a result, the cam follower 170 slides from the pushing position to the non-pushing position shown in FIGS. 6A and 6B by the biasing force of the spring 430 (see FIGS. 9A and 9B).

Thus, the development cartridge 60 moves from the second position to the first position, and the development roller 61 moves from the separated position to the contact position. In this manner, when the main motor M1 rotates in the forward direction, the separation cam 150 moves the development roller 61 from the separated position to the contact position.

On the other hand, when the main motor M1 rotates in the reverse direction, the separation cam 150 rotates in the second rotation direction R2. Then, the arm 172 of the cam follower 170 contacts the inclined surface F3 of the cam portion 153, slides on the inclined surface F3, and then contacts the second surface F2. That is, when the main motor M1 rotates in the reverse direction, the cam follower 170 relatively moves with respect to the separation cam 150 in a direction from the first surface F1 toward the second surface F2 via the inclined surface F3. As a result, the cam follower 170 slides from the non-pushing position to the pushing position shown in FIGS. 7A and 7B.

Thus, the development cartridge 60 is pushed by the cam follower 170 and moves from the first position to the second position, and the development roller 61 moves from the contact position to the separated position. In this manner, when the main motor M1 rotates in the reverse direction, the separation cam 150 moves the development roller 61 from the contact position to the separated position.

As shown in FIG. 3, the development separation gear train GT1 includes a color-side gear train GT11 and a monochrome-side gear train GT12.

The color-side gear train GT11 is constituted by one or more gears, belts, and the like, and is a gear train that transmits a driving force of the main motor M1 to the separation cams 150Y, 150M, and 150C. The color-side gear train GT11 connects the main motor M1 and the separation cams 150Y, 150M, and 150C.

The color-side gear train GT11 includes an electromagnetic clutch EC1, a plurality of gears that transmit a driving force of the main motor M1 to the electromagnetic clutch EC1, a cam gear 115C, a gear 116, a cam gear 115M, a gear 118, and a cam gear 115Y.

The electromagnetic clutch EC1 is switchable between a transmission state and a cutoff state. As an example, the electromagnetic clutch EC1 enters the transmission state when energized, and enters the cutoff state when not energized. The transmission state is a state in which a driving force from the main motor M1 is transmitted to the separation cams 150Y, 150M, and 150C. The cutoff state is a state in which a driving force from the main motor M1 is not transmitted to the separation cams 150Y, 150M, and 150C. The electromagnetic clutch EC1 is controlled by the controller 2 (see FIG. 1).

The cam gear 115C is a gear including the separation cam 150C. In other words, the separation cam 150C includes gear teeth on an outer periphery of its disk portion 151. When the electromagnetic clutch EC1 is in the transmission state, a driving force of the main motor M1 is transmitted through the plurality of gears and the cam gear 115C rotates. When the electromagnetic clutch EC1 is in the cutoff state, the cam gear 115C does not rotate since a driving force is not transmitted from the main motor M1.

The gear 116 meshes with the cam gear 115C.

The cam gear 115M is a gear including the separation cam 150M. In other words, the separation cam 150M includes gear teeth on the outer periphery of its disk portion 151. The cam gear 115M meshes with the gear 116. The cam gear 115M receives a driving force of the main motor M1 from the cam gear 115C via the gear 116.

The gear 118 meshes with the cam gear 115M.

The cam gear 115Y is a gear including the separation cam 150Y. In other words, the separation cam 150Y includes gear teeth on the outer periphery of its disk portion 151. The cam gear 115Y meshes with the gear 118.

The separation cams 150Y, 150M, and 150C rotate in conjunction with each other. In the separation cams 150Y, 150M, and 150C, the length of the second surface F2 in the rotation direction of the separation cam 150 increases in an order of the separation cam 150Y, the separation cam 150M, and the separation cam 150C. In the separation cams 150Y, 150M, and 150C, the phases of downstream ends of the second surfaces F2 in the first rotation direction R1 are aligned, and phases of the inclined surfaces F3 are shifted. Specifically, the inclined surface F3 of the separation cam 150Y is located further downstream in the first rotation direction R1 than the inclined surface F3 of the separation cam 150M, and the inclined surface F3 of the separation cam 150M is located further downstream in the first rotation direction R1 than the inclined surface F3 of the separation cam 150C.

Thus, when the main motor M1 rotates in the forward direction and the separation cams 150Y, 150M, and 150C rotate in the first rotation direction R1 from a state where the cam followers 170Y, 170M, and 170C are located at the pushing position, first, the cam follower 170Y moves from the pushing position to the non-pushing position, whereby the development roller 61Y moves from the separated position to the contact position. Next, the cam follower 170M moves from the pushing position to the non-pushing position, whereby the development roller 61M moves from the separated position to the contact position. Finally, the cam follower 170C moves from the pushing position to the non-pushing position, whereby the development roller 61C moves from the separated position to the contact position.

On the other hand, when the main motor M1 rotates in the reverse direction and the separation cams 150Y, 150M, and 150C rotate in the second rotation direction R2 from a state where the cam followers 170Y, 170M, and 170C are located at the non-pushing position, first, the cam follower 170C moves from the non-pushing position to the pushing position, whereby the development roller 61C moves from the contact position to the separated position. Next, the cam follower 170M moves from the non-pushing position to the pushing position, whereby the development roller 61M moves from the contact position to the separated position. Finally, the cam follower 170Y moves from the non-pushing position to the pushing position, whereby the development roller 61Y moves from the contact position to the separated position.

The monochrome-side gear train GT12 is constituted by one or more gears, belts, and the like, and is a gear train that transmits a driving force of the main motor M1 to the separation cam 150K. The monochrome-side gear train GT12 connects the main motor M1 and the separation cam 150K. The monochrome-side gear train GT12 includes an electromagnetic clutch EC2, a plurality of gears that transmit a driving force of the main motor M1 to the electromagnetic clutch EC2, and the cam gear 115K.

The electromagnetic clutch EC2 is switchable between a transmission state and a cutoff state. As an example, the electromagnetic clutch EC2 enters the transmission state when energized, and enters the cutoff state when not energized. The transmission state is a state in which a driving force from the main motor M1 is transmitted to the separation cam 150K. The cutoff state is a state in which a driving force from the main motor M1 is not transmitted to the separation cam 150K. The electromagnetic clutch EC2 is controlled by the controller 2 (see FIG. 1).

The cam gear 115K is a gear including the separation cam 150K. In other words, the separation cam 150K includes gear teeth on the outer periphery of its disk portion 151. When the electromagnetic clutch EC2 is in the transmission state, a driving force of the main motor M1 is transmitted through the plurality of gears and the cam gear 115K rotates. When the electromagnetic clutch EC2 is in the cutoff state, the cam gear 115K does not rotate since a driving force is not transmitted from the main motor M1.

As shown in FIG. 3, the image forming apparatus 1 further includes sensors 4K and 4C. The sensors 4K and 4C are sensors that detect positions of the cam followers 170.

The sensor 4K detects a position of the cam follower 170K in the axial direction. The sensor 4C detects positions of the cam followers 170Y, 170M, and 170C in the axial direction. The sensor 4C directly detects a position of the cam follower 170C, and indirectly detects positions of the cam followers 170Y and 170M.

The sensors 4K and 4C are photo-interrupters. Each of the sensors 4K and 4C include a light emitting portion 4P and a light receiving portion 4R. The light emitting portion 4P emits detection light, and the light receiving portion 4R is configured to receive the detection light from the light emitting portion 4P. The sensors 4K and 4C are passed through the through holes 550 (see FIG. 9A and 9B) of the gear cover 500 such that the light emitting portions 4P and the light receiving portions 4R are located inside the gear cover 500.

The gear cover 500 supports the sensors 4K and 4C. As shown in FIGS. 3, 6B and 7B, the light emitting portion 4P and the light receiving portion 4R are closer, than the cam portion 153, to the rotation axis X1 of the separation cam 150.

As shown in FIGS. 6A, 7A, 9A, and 9B, when the cam follower 170K is located at the pushing position, the protrusion 174 enters between the light emitting portion 4P and the light receiving portion 4R, and when the cam follower 170K is located at the non-pushing position, the protrusion 174 is located at a position where the protrusion 174 is removed from between the light emitting portion 4P and the light receiving portion 4R. Similarly, when the cam follower 170C is located at the pushing position, the protrusion 174 enters between the light emitting portion 4P and the light receiving portion 4R, and when the cam follower 170C is located at the non-pushing position, the protrusion 174 is located at a position where the protrusion 174 is removed from between the light emitting portion 4P and the light receiving portion 4R.

Thus, when the cam follower 170 is located at the pushing position, the light receiving portion 4R of each of the sensors 4K and 4C cannot receive detection light from the light emitting portion 4P because the detection light is blocked by the protrusion 174. Further, when the cam follower 170 is located at the non-pushing position, the light receiving portion 4R of each of the sensors 4K and 4C receives detection light from the light emitting portion 4P. The sensors 4K and 4C detect whether the cam follower 170 is located at the pushing position or the non-pushing position based on a change in a received-light state of the detection light.

When the cam follower 170 is located at the pushing position, the corresponding development roller 61 is located at the separated position, and when the cam follower 170 is located at the non-pushing position, the corresponding development roller 61 is located at the contact position. Accordingly, the sensors 4K and 4C can detect whether the development roller 61 is located at the separated position or the contact position via the cam follower 170.

The protrusion 174 of the cam follower 170K is detectable by the sensor 4K, and the protrusion 174 of the cam follower 170C is detectable by the sensor 4C.

The sensor 4K detects the protrusion 174 of the cam follower 170K when the separation cam 150K is located at the second phase.

The sensor 4C detects the protrusion 174 of the cam follower 170C when the separation cam 150C is located at the second phase.

In the present embodiment, the four cam followers 170 are common parts and all include the protrusion 174, but the protrusions 174 of the cam followers 170Y and 170M do not function as portions to be detected by the sensors 4K and 4C.

The controller 2 (see FIG. 1) includes a central processing unit (CPU), a random-access memory (RAM), a read-only memory (ROM), and an input/output circuit, and executes control by executing a program stored in advance. The controller 2 controls driving and stopping of the main motor M1, and controls a rotation direction of an output shaft of the main motor M1. Further, the controller 2 controls driving and stopping of the process motor M2. Further, the controller 2 controls the electromagnetic clutches EC1 and EC2.

Thus, the controller 2 controls contact and separation of the development rollers 61 with respect to the corresponding photosensitive drums 50. Further, the controller 2 controls driving and stopping of the photosensitive drums 50, the development rollers 61, and the heating roller 81A. Further, the controller 2 controls the nip pressure between the heating unit 81 and the pressure unit 82 of the fixing device 80.

The controller 2 is capable of executing a color printing mode and a monochrome printing mode.

The color printing mode is a printing mode in which an image is formed on the sheet S using the development roller 61Y, the development roller 61M, the development roller 61C, and the development roller 61K.

After executing an initialization operation and a warming-up operation, the controller 2 sets the image forming apparatus 1 to a standby state in which the image forming apparatus 1 waits for reception of a print job. In the standby state, the image forming apparatus 1 sets all of the development rollers 61 to be located at their separated positions and stops the development rollers 61 and the photosensitive drums 50. When receiving a print job, the controller 2 executes a printing operation. When image data included in the print job is a color image, the controller 2 executes the color printing mode. When the image data is a monochrome image, the controller 2 executes the monochrome printing mode.

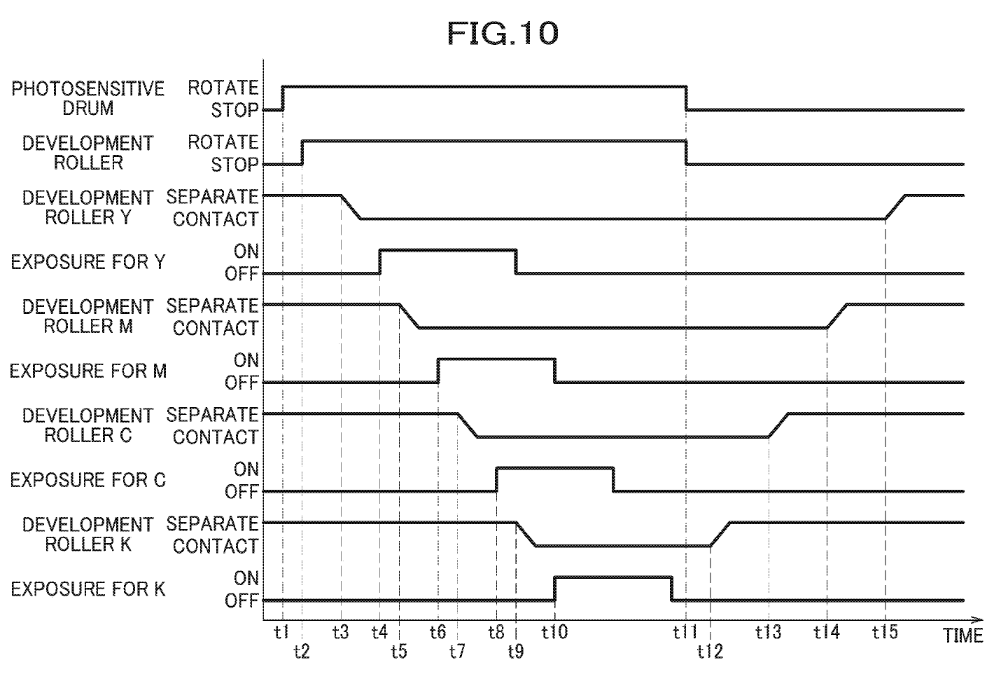

Next, with reference to the timing chart of FIG. 10, a print process when executing color printing will be described. In the timing chart of FIG. 10, a process for rotation/stop of the photosensitive drums 50 and the development rollers 61 from the standby state, exposure of the photosensitive drums 50, and operation of the separation mechanism 5 will be described. In the figure, exposure being ON indicates that an area on the surface of the photosensitive drum 50 where an electrostatic image is to be formed by exposure is being exposed. FIG. 10 shows a case where an image is formed on the entire surface of the sheet S.

As shown in FIG. 10, in the image forming apparatus 1 of the present embodiment, the photosensitive drums 50 start rotating (time t1), and then the development rollers 61 start rotating (time t2). Further, as the sheet S is conveyed on the transfer belt 73 from upstream to downstream, exposure is sequentially performed. Exposure for the respective colors Y, M, C, and K is sequentially performed in an order of Y (time t4), M (time t6), C (time t8), and K (time t10). Further, as the sheet S is conveyed on the transfer belt 73 from upstream to downstream, the development rollers 61 sequentially contact the corresponding photosensitive drums 50. Movement of the development rollers 61 toward the contact positions starts in an order of the development roller 61Y (time t3), the development roller 61M (time t5), the development roller 61C (time t7), and the development roller 61K (time t9). Then, after the development is completed, rotation of the development rollers 61 and the photosensitive drums 50 stops (time t11). Next, the development rollers 61 are sequentially separated from the corresponding photosensitive drums 50. Separation is started in an order of the development roller 61K (time t12), the development roller 61C (time t13), the development roller 61M (time t14), and the development roller 61Y (time t15).

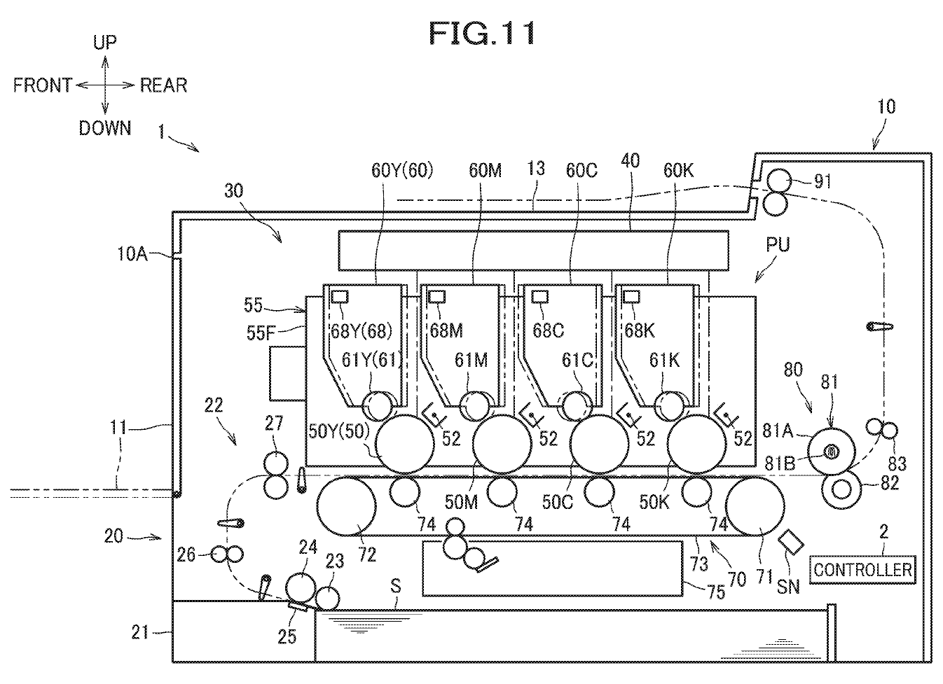

In the image forming apparatus 1 as described above, when the separation mechanism 5 does not operate normally, for example, a state as shown in FIG. 11 occurs.

FIG. 11 shows a state after the controller 2 controls the separation mechanism 5 from the state of FIG. 1 and executes a process to move the development roller 61 from the contact position to the separated position. In FIG. 11, each development cartridge 60 other than the development cartridge 60C has moved from the contact position shown by a chain double-dotted line to the separated position shown by a solid line. However, due to an abnormality of the separation mechanism 5, the development cartridge 60C is located at the contact position shown by the solid line. Since the development cartridge 60C is located at the contact position, the development roller 61C is constantly in contact with the photosensitive drum 50. The separation mechanism 5 includes the separation shaft 66 of the development cartridge 60, and a state as shown in FIG. 11 can also occur when an abnormality exists in the separation shaft 66.

When the development roller 61 is constantly in contact with the photosensitive drum 50, a situation occurs where the development roller 61 in a stopped state contacts the photosensitive drum 50 that is rotating. When the image forming apparatus 1 is continuously used in this state, a load is exerted on the development roller 61 and the photosensitive drum 50, which may lead to print defects and failures.

In order to suppress occurrence of such print defects and failures, the image forming apparatus 1 is capable of executing a process for inspecting the separation mechanism 5 for an abnormality.

In order to inspect the separation mechanism 5 for an abnormality, the controller 2 continuously executes a print preparation process and an abnormality inspection process.

In the print preparation process, the controller 2 controls the separation mechanism 5 to move the development cartridges 60 such that the development rollers 61 are located at the separated positions. Next, the controller 2 controls the process motor M2 to start rotation of the photosensitive drums 50 and the development rollers 61. Then, the surfaces of the photosensitive drums 50 are charged by the chargers 52.

In the abnormality inspection process, the controller 2 forms electrostatic latent images of the patch images P on the surfaces of the photosensitive drums 50 by exposure. Next, the controller 2 applies, to the transfer unit 70, a transfer bias that enables the patch images P to be moved from the photosensitive drums 50 to the transfer belt 73. Then, the controller 2 determines presence or absence of the patch images P on the transfer belt 73 by the density sensors SN.

When the separation mechanism 5 is operating normally, since toner is not supplied to the photosensitive drums 50, the patch images P are not transferred to the transfer belt 73. Therefore, the patch images P are not detected by the density sensors SN.

On the other hand, when any of the development rollers 61 remains at the contact position, toner is supplied from the development roller 61 to the photosensitive drum 50, as shown in FIG. 11. By the supplied toner, the patch image P is transferred to the transfer belt 73. Accordingly, the density sensors SN detect the patch image P. By the density sensors SN detecting the patch image P, it is possible to determine that an abnormality has occurred in the separation mechanism 5.

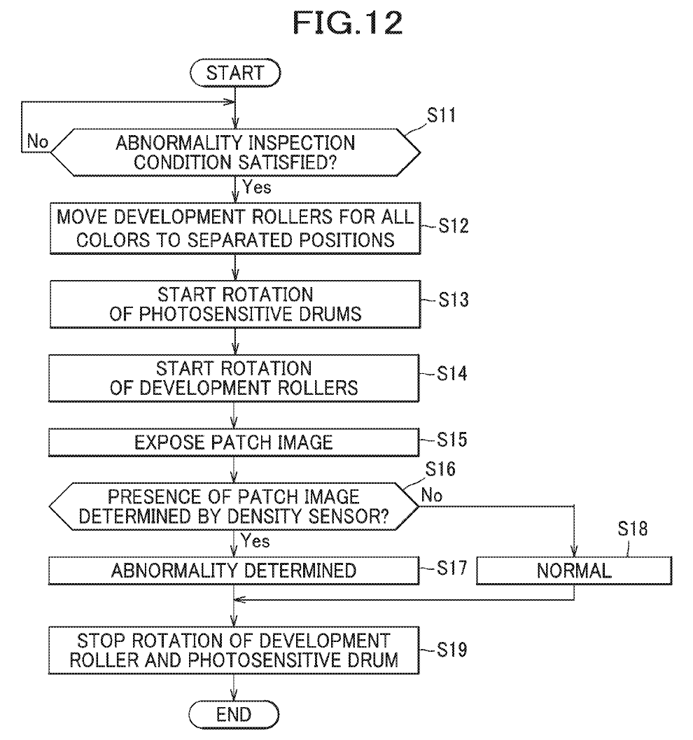

In order to execute inspection of the separation mechanism 5 for an abnormality as described above, the controller 2 executes the process shown in FIG. 12.

In the process of FIG. 12, the controller 2 first determines whether an abnormality inspection condition is satisfied (S11). The abnormality inspection condition is, for example, the following (1) to (4).
(1) Opening and closing of the front cover 11 has been detected.
(2) A predetermined time has elapsed since inspection of the separation mechanism for an abnormality was last performed.
(3) It has been determined that the development cartridge 60 is new based on new-product information read from the development memory 68.
(4) It has been determined that unique identification information read from the development memory 68 is different from unique identification information of a cartridge attached immediately previously.

If any of (1) to (4) is satisfied, the controller 2 determines that the abnormality inspection condition is satisfied. If the abnormality inspection condition is not satisfied (No), the controller 2 stands by until the abnormality inspection condition is satisfied.

If the abnormality inspection condition is satisfied (Yes), the controller 2 controls the separation mechanism 5 such that development rollers 61 for all colors move to the separated positions (S12). After controlling the separation mechanism 5 such that the development rollers 61 for all colors move to the separated positions, the controller 2 starts rotation of the photosensitive drums 50 (S13).

After the start of rotation of the photosensitive drums 50, the controller 2 starts rotation of the development rollers 61 (S14).

After the start of rotation of the development rollers 61, the controller 2 charges the photosensitive drums 50 and forms electrostatic latent images of the patch images P on the photosensitive drums 50 by exposure (S15).

After step S15, the controller 2 applies to the transfer unit 70 a transfer bias that enables the patch images P to be moved from the photosensitive drums 50 to the transfer belt 73. Then, the controller 2 determines presence or absence of the patch images P on the transfer belt 73 by the density sensors SN (S16). If it is determined that the patch image P is not present on the transfer belt 73 (No), the controller 2 determines that no abnormality exists in the separation mechanism 5, that is, the separation mechanism 5 is operating normally (S18). If it is determined that the patch image P is present on the transfer belt 73 (Yes, S17), the controller 2 determines that an abnormality exists in the separation mechanism 5. If it is determined that an abnormality exists in the separation mechanism 5, the controller 2 notifies a user of the abnormality of the separation mechanism 5. Examples of the notification method include a method of displaying an image indicating that an abnormality exists in the separation mechanism 5 on a display of the image forming apparatus 1.

After determining presence or absence of the patch image P, the controller 2 stops rotation of the development rollers 61 and the photosensitive drums 50 (S19) and proceeds to the standby state.

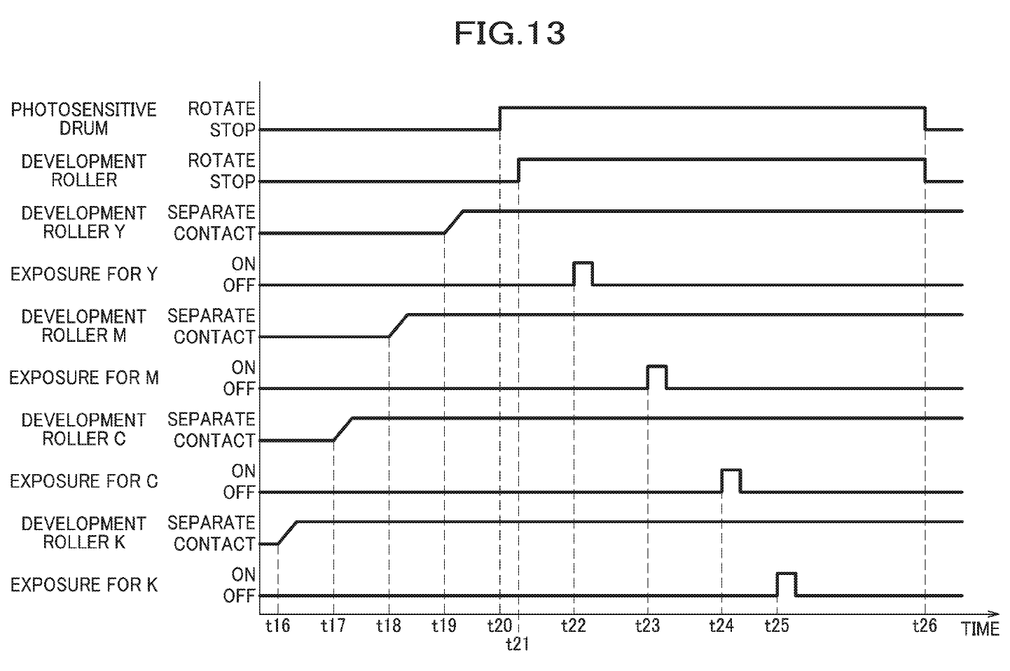

Next, with reference to the timing chart of FIG. 13, operation when executing the abnormality inspection process will be described.

After determining that the abnormality inspection condition is satisfied, the controller 2 sequentially moves the development rollers 61 to the separated positions and sets the image forming apparatus 1 to the standby state. Movement to the separated positions is performed in an order of the development roller 61K (time t16), the development roller 61C (time t17), the development roller 61M (time t18), and the development roller 61Y (time t19).

After proceeding to the standby state, the controller 2 starts rotation of the photosensitive drums 50 (time t20), and then starts rotation of the development rollers 61 (time t21). Then, the controller 2 sequentially performs exposure of the patch images P on the photosensitive drums 50. Exposure of the patch images P is sequentially performed in an order of Y (time t22), M (time t23), C (time t24), and K (time t25). This exposure of the patch images P is shorter than that performed when forming an image on the entire surface of the sheet in FIG. 10. After the start of exposure of the patch images P, detection of the patch images P is performed by the density sensors SN. After a portion of the transfer belt 73, which corresponds to an area where the patch images P can be exposed, passes through a detection range of the density sensors SN, rotation of the development rollers 61 and the photosensitive drums 50 is stopped (time t26).

According to the image forming apparatus 1 of the above-described present embodiment, the following advantageous effects can be achieved.

By determining presence or absence of a toner image on the transfer belt 73 when inspecting the separation mechanism 5 for an abnormality, an abnormality of the separation mechanism 5 can be easily determined.

Further, since inspection of the abnormality is performed in a state where the development roller 61 is at the separated position, consumption of toner can be suppressed when the separation mechanism 5 is operating normally.

By using the patch image P as a test image, it is possible to inspect the separation mechanism 5 for an abnormality while performing density correction using the patch image P.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above-described embodiment, the transfer medium is the sheet S, but the transfer medium may be a transfer belt. That is, the transfer belt 73 may be an intermediate transfer belt.

In the above-described embodiment, an example using a rotating cam as the separation mechanism has been described, but the separation mechanism may have other configurations, such as a configuration using a linearly moving cam.

The exposure unit may be an LED unit.

The number of motors is not limited to a specific number, and may be one or may be three or more.

In the above-described embodiment, the development roller 61Y, the development roller 61M, the development roller 61C, and the development roller 61K rotate and stop at the same timing, but the present disclosure is not limited thereto. The development rollers 61 may sequentially rotate and stop in an order of the development roller 61Y, the development roller 61M, the development roller 61C, and the development roller 61K as the sheet S is conveyed on the transfer belt 73 from upstream to downstream.

In the above-described embodiment, as the sheet S is conveyed on the transfer belt 73 from upstream to downstream, the development roller 61Y, the development roller 61M, the development roller 61C, and the development roller 61K contact or separate from the photosensitive drums 50 at different timings, but the present disclosure is not limited thereto. The development roller 61Y, the development roller 61M, the development roller 61C, and the development roller 61K may be configured to contact or separate from the photosensitive drums 50 at the same timing.

In the above-described embodiment, a color printer is given as an example of the image forming apparatus, but the image forming apparatus may be an image forming apparatus that forms a monochrome image. Further, the image forming apparatus may be a copying machine or a multifunction machine, etc.

The elements described in the above embodiments and its modifications may be implemented selectively and in combination.

What is claimed is:

1. An image forming apparatus, comprising:
a first photosensitive drum;
a first development roller configured to supply toner to the first photosensitive drum;
at least one motor configured to rotate the first photosensitive drum and the first development roller;
a separation mechanism configured to move the first development roller between a contact position in which the first development roller contacts the first photosensitive drum and a separated position in which the first development roller is separated from the first photosensitive drum;
a charger configured to charge the first photosensitive drum;
an exposure unit configured to expose the first photosensitive drum;
a transfer unit configured to transfer a toner image formed on the first photosensitive drum to a transfer medium, the transfer unit comprising:
a transfer belt configured to move in contact with the first photosensitive drum; and
a transfer roller configured to nip the transfer belt in combination with the first photosensitive drum;
a sensor configured to detect a toner image on the transfer belt; and
a controller,
wherein the controller is configured to:
perform a print preparation process in which:
the first development roller is positioned at the separated position by controlling the separation mechanism;
the first development roller and the first photosensitive drum are rotated by controlling the at least one motor; and
the first photosensitive drum is charged by controlling the charger; and
perform an abnormality inspection process in which:
a test image is formed on the first photosensitive drum by exposure;
a transfer bias that enables a toner image to be moved from the first photosensitive drum to the transfer belt is applied to the transfer unit;
presence or absence of a toner image of the test image on the transfer belt is determined by the sensor;
if the toner image is detected by the sensor, the controller determines that an abnormality exists in the separation mechanism, and
if the toner image is not detected by the sensor, the controller determines that no abnormality exists in the separation mechanism; and
wherein, when inspecting the separation mechanism for an abnormality, the abnormality inspection process is executed following the print preparation process.

2. The image forming apparatus according to claim 1, further comprising:
a second photosensitive drum disposed downstream of the first photosensitive drum in a movement direction in which the transfer medium moves at a position where the transfer medium faces the first photosensitive drum;
a third photosensitive drum disposed downstream of the second photosensitive drum in the movement direction; and
a fourth photosensitive drum disposed downstream of the third photosensitive drum in the movement direction;
a second development roller configured to supply toner to the second photosensitive drum;
a third development roller configured to supply toner to the third photosensitive drum; and
a fourth development roller configured to supply toner to the fourth photosensitive drum,
wherein the transfer unit is further configured to transfer toner images formed on the second photosensitive drum, the third photosensitive drum, and the fourth photosensitive drum to the transfer medium, and
wherein the separation mechanism is further configured to move the second development roller, the third development roller, and the fourth development roller, respectively, between a contact position in which each development roller contacts a corresponding photosensitive drum and a separated position in which each development roller is separated from the corresponding photosensitive drum.

3. The image forming apparatus according to claim 2, wherein the separation mechanism is configured to:
sequentially bring the first development roller, the second development roller, the third development roller, and the fourth development roller into contact with the corresponding photosensitive drums in this order in accordance with movement of the transfer medium; and
sequentially separate the fourth development roller, the third development roller, the second development roller, and the first development roller from the corresponding photosensitive drums in this order after completion of development.

4. The image forming apparatus according to claim 1, further comprising:
a main housing;
an opening provided in the main housing;
a cover configured to open and close the opening; and
a process unit attachable to and detachable from the main housing through the opening, the process unit comprising the first development roller and the first photosensitive drum,
wherein the controller is configured to inspect the separation mechanism for an abnormality when detecting opening or closing of the cover.

5. The image forming apparatus according to claim 1, wherein the controller is configured to inspect the separation mechanism for an abnormality at each predetermined time interval.

6. The image forming apparatus according to claim 1, further comprising:
a main housing; and
a development cartridge attachable to and detachable from the main housing, comprising a memory, the first development roller, and a toner case that contains toner,
wherein the memory stores new-product information indicating whether or not the development cartridge is new, and
wherein the controller is configured to read the new-product information from the memory and to inspect the separation mechanism for an abnormality if it is determined, based on the read new-product information, that the development cartridge is new.

7. The image forming apparatus according to claim 1, further comprising:
a main housing; and
a development cartridge attachable to and detachable from the main housing, comprising a memory that stores unique identification information, the first development roller, and a toner case that contains toner,
wherein the controller is configured to read unique identification information from the memory and to inspect the separation mechanism for an abnormality if the read unique identification information is different from unique identification information of a development cartridge attached immediately previously.
